(19) United States
(12) Patent Application Publication
(10) Pub. No.: US 2020/0172434 A1
(43) Pub. Date: Jun. 4, 2020

(54) APPARATUS AND METHOD OF DELIVERING SOLID CHEMICALS AND RETAINING SLUDGE IN MOLTEN SALT BATH

(71) Applicant: CORNING INCORPORATED, Corning, NY (US)

(72) Inventors: John Martin Dafin, Christiansburg, VA (US); Jeffrey Alan Decker, Horseheads, NY (US); William Jason Hill, Lindley, NY (US); Yuhui Jin, Painted Post, NY (US); James Paul McCann, Horseheads, NY (US); Alan Scott McCarthy, Painted Post, NY (US)

(21) Appl. No.: 16/692,097

(22) Filed: Nov. 22, 2019

Related U.S. Application Data
(60) Provisional application No. 62/773,538, filed on Nov. 30, 2018.

(51) Int. Cl. C03C 21/00

(52) U.S. Cl. CPC C03C 21/002

(57) ABSTRACT

Methods and apparatuses for delivering and retaining solid chemicals in molten salt baths are provided, the chemicals may serve to reduce the lithium poisoning level of the molten salt bath. Methods and apparatuses are also provided for retaining sludge in a molten salt bath, allowing for removal of the sludge from the molten salt bath.

### CROSS-REFERENCE TO RELATED APPLICATIONS

This application claims the benefit of priority of U.S. Provisional Application Ser. No. 62/773,538 filed on Nov. 30, 2018, the content of which is relied upon and incorporated herein by reference in its entirety.

### BACKGROUND

### Field

This disclosure relates to methods and apparatuses for delivering solid chemicals to molten salt baths as well as retaining sludge in the molten salt baths.

### Technical Background

Molten salt baths that are utilized for ion exchange of glass articles gradually become poisoned as ions migrate from the glass articles and into the molten salt bath. For example, lithium ions may migrate out of the glass articles and into the molten salt bath, forming lithium nitrate. If the concentration of lithium nitrate becomes too high in the molten salt bath, the bath may no longer be capable of effective ion exchange. Trisodium phosphate (TSP) has been added to molten salt baths to reduce the lithium nitrate concentration in the bath, and restore the ion exchange effectiveness of the molten salt bath. Current methods of adding TSP to the molten salt bath may cause the bath to become cloudy, which requires waiting for the bath to clear before production can resume to avoid particulates sticking to the surface of the ion exchanged glass articles. Additionally, current methods of adding TSP to the molten salt bath may expose workers to dangerous environments.

The reaction of TSP with lithium nitrate forms lithium phosphate, which precipitates from the bath forming a sludge like material. Eventually, the molten salt bath tank must be drained to remove the sludge which causes process down time.

Accordingly, a need exists for improved methods of adding TSP to molten salt baths and removing sludge from the molten salt bath.

### SUMMARY

In aspect (1), an apparatus is provided. The apparatus comprises: a tank containing a molten nitrate salt; a delivery vehicle at least partially submerged in the molten nitrate salt, wherein the delivery vehicle comprises: trisodium phosphate particles with a minimum particle size, a plurality of openings with a maximum opening size less than the minimum particle size of the trisodium phosphate.

In aspect (2), the apparatus of aspect (1) is provided, wherein the delivery vehicle further comprises a metal mesh, and a plurality of openings are formed in the metal mesh.

In aspect (3), the apparatus of aspect (2) is provided, wherein the delivery vehicle further comprises a frame supporting the metal mesh.

In aspect (4), the apparatus of any one of aspects (1) to (3) is provided, wherein the molten nitrate salt comprises LiNO₃.

In aspect (5), the apparatus of any one of aspects (1) to (4) is provided, wherein the delivery vehicle is fully submerged in the molten nitrate salt.

In aspect (6), the apparatus of any one of aspects (1) to (5) is provided, further comprising a movement mechanism configured to move the delivery vehicle into and out of contact with the molten nitrate salt.

In aspect (7), a method is provided. The method comprises: at least partially submerging a delivery vehicle in a molten nitrate salt contained in a tank, wherein: the molten nitrate salt comprises LiNO₃, and the delivery vehicle comprises: trisodium phosphate particles with a minimum particle size, a plurality of openings with a maximum opening size less than the minimum particle size of the trisodium phosphate.

In aspect (8), the method of aspect (7) is provided, wherein at least partially submerging the delivery vehicle comprises activating a movement mechanism configured to move the delivery vehicle into contact with the molten nitrate salt.

In aspect (9), the method of aspect (7) or (8) is provided, further comprising removing the delivery vehicle from contact with the molten nitrate salt.

In aspect (10), the method of any one of aspects (7) to (9) is provided, wherein the at least partially submerging the delivery vehicle comprises attaching the delivery vehicle to a glass holding cassette configured to hold glass to be ion exchanged in the molten nitrate salt, and submerging the glass holding cassette in the molten nitrate salt.

In aspect (11), an apparatus is provided. The apparatus comprises: a tank containing molten nitrate salt; and a tray submerged in the molten nitrate salt and disposed proximate to the bottom of the tank, wherein the tray has a shape that is configured to substantially match the interior shape of the tank, and the tray is removable from the molten nitrate salt.

In aspect (12), the apparatus of aspect (11) is provided, wherein the tray comprises stainless steel.

In aspect (13), the apparatus of aspect (11) or (12) is provided, wherein the tray comprises a plurality of openings configured to allow the flow of the molten nitrate salt.

In aspect (14), the apparatus of any one of aspects (11) to (13) is provided, wherein the tray is supported by the bottom of the tank.

In aspect (15), the apparatus of any one of aspects (11) to (14) is provided, wherein the tray is suspended above the bottom of the tank.

In aspect (16), a method is provided. The method comprises: submerging a tray in a molten nitrate salt contained in a tank, wherein the tray is disposed proximate to the bottom of the tank, and the tray has a shape that is configured to substantially match the interior shape of the tank; adding trisodium phosphate to the molten nitrate salt, wherein the molten nitrate salt contains LiNO₃; and removing the tray from the molten nitrate salt.

In aspect (17), the method of aspect (16) is provided, further comprising submerging a second tray the molten nitrate salt after removing the tray, wherein the second tray is disposed proximate to the bottom of the tank, and the second tray has a shape that is configured to substantially match the interior shape of the tank.

In aspect (18), the method of aspect (16) or (17) is provided, wherein the molten salt comprises greater than or equal to 1 wt % LiNO₃ prior to the addition of the trisodium phosphate.

In aspect (19), the method of any one of aspects (16) to (18) is provided, further comprising cleaning the tray after removing the tray from the molten nitrate salt.

In aspect (20), the method of any one of aspects (16) to (19) is provided, wherein the molten nitrate salt is at a temperature of greater than or equal to 300° C.

These and other aspects, advantages, and salient features will become apparent from the following detailed description, the accompanying drawings, and the appended claims.

### BRIEF DESCRIPTION OF THE DRAWINGS

FIG. 1 is a schematic cross section of a molten salt bath tank including a delivery vehicle and tray according to an embodiment;

FIG. 2 is a perspective view of a delivery vehicle according to an embodiment;

FIG. 3 is a perspective view of a frame for a delivery vehicle according to an embodiment;

FIG. 4 is a perspective view of a sludge retaining tray according to an embodiment;

FIG. 5 is a perspective view of a sludge retaining tray according to an embodiment;

FIG. 6 is a plot of the lithium concentration of a molten salt bath as a function of time after TSP addition.

### DETAILED DESCRIPTION

Methods and apparatuses are provided herein for adding trisodium phosphate to molten salt baths and for retaining and removing sludge from molten salt baths. The approaches described herein allow for decreased downtime of molten salt bath tanks and improved worker safety.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. Unless otherwise specified, a range of values, when recited, includes both the upper and lower limits of the range as well as any sub-ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

Unless otherwise specified, all temperatures are expressed herein in terms of degrees Celsius (° C.).

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. As utilized herein, when the term “about” is used to modify a value, the exact value is also disclosed. For example, the term “greater than about 10 mol %” also discloses “greater than or equal to 10 mol %.”

Reference will now be made in detail to various embodiments, examples of which are illustrated in the accompanying examples and drawings.

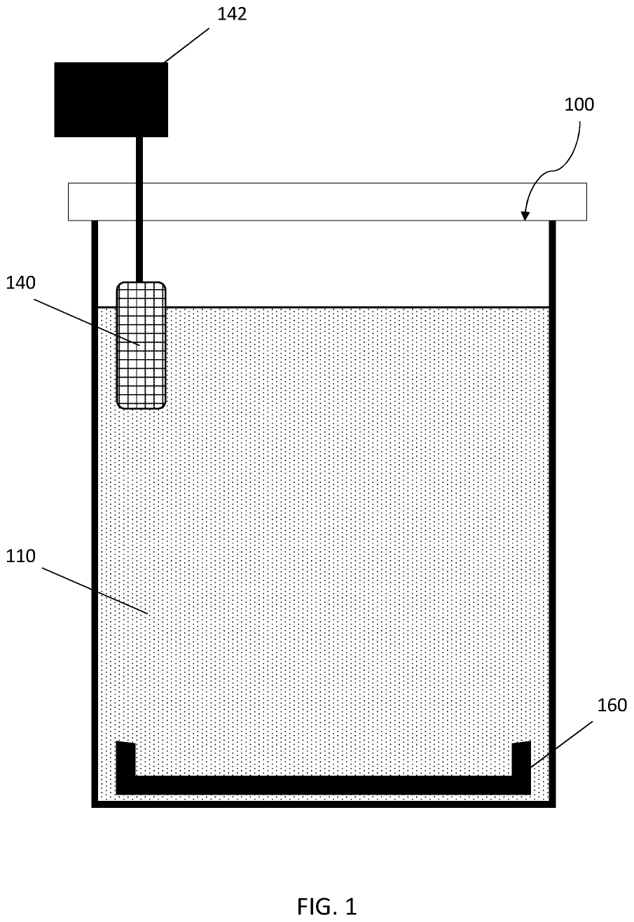

FIG. 1 shows a cross section view of a molten salt bath tank 100 containing a molten salt bath 110. A delivery vehicle 140 is partially submerged in the molten salt bath 110 and attached to movement mechanism 142. A tray 160 is also submerged in the molten salt bath 110 and disposed near the bottom of the molten salt bath tank 100. FIG. 1 shows the delivery vehicle 140 and tray 160 being used together, in other embodiments the delivery vehicle 140 and tray 160 may be utilized separately.

The delivery vehicle is configured to contain trisodium phosphate (TSP) while also allowing the molten salt bath to enter the delivery vehicle through openings therein and react with the TSP when the delivery vehicle is at least partially submerged in the molten salt bath. This allows the lithium nitrate in the molten salt bath to react with the TSP without uncontrolled addition of TSP to the molten salt bath.

Pre-existing methods of adding TSP to molten salt baths include broadcasting TSP particles over the surface of the molten salt bath. This method may expose workers to the hot surface of the molten salt bath, providing the opportunity for injury. Additionally, the addition of TSP to the surface of the bath generally may render the bath cloudy, and ion exchanging glass in a cloudy bath may allow hard to clean TSP or sludge particles to stick to the surface of the glass articles.

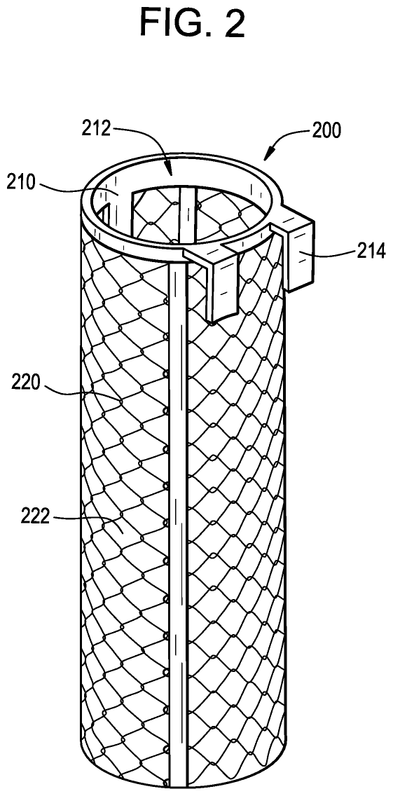

The delivery vehicle includes openings configured to allow the molten salt to pass through and interact with the TSP, but prevent the TSP particles from exiting the delivery vehicle. The retention of the TSP in the delivery vehicle reduces the cloudiness of the bath upon addition of the TSP, reducing downtime. FIG. 2 is a perspective view of a delivery vehicle 200 according to an embodiment. The delivery vehicle 200 includes a frame 210 covered by a wire mesh 220. The wire mesh includes a plurality of openings 222 which have a maximum opening size that is less than the minimum particle size of TSP loaded into the delivery vehicle. This size relationship between the mesh openings and the TSP particle size ensures that the TSP is maintained within the delivery vehicle. The delivery vehicle 200 includes an orifice 212 to allow TSP particles to be added to the delivery vehicle. In some embodiments, the orifice 212 may be closable, such as by a cover (not shown), to allow the delivery vehicle to be completely submerged in the molten salt bath while retaining the TSP. The delivery vehicle may also include an attachment mechanism 214 to allow the delivery vehicle 200 to be attached to existing fixtures utilized in other aspects of the ion exchange process, such as a cassette configured to hold glass during the ion exchange process. In some embodiments, the delivery vehicle 200 may be attached by the attachment mechanism 214 to a movement mechanism 142 configured to move the delivery vehice in and out of the molten salt bath.

The wire mesh 220 of the delivery vehicle may be formed from any material capable of withstanding the high temperature environment of the molten salt bath. In embodiments, the wire mesh may be a stainless steel mesh. Additionally, the wire mesh may be substituted by other materials that include openings having the same effect, such as perforated sheets. The openings in the wire mesh may be in the range from 10 μm to 500 μm, such as from 20 μm to 490 μm, from 30 μm to 480 μm, from 40 μm to 460 μm, from 50 μm to 450 μm, from 60 μm to 440 μm, from 70 μm to 430 μm, from 80 μm to 420 μm, from 90 μm to 410 μm, from 100 μm to 400 μm, from 110 μm to 390 μm, from 120 μm to 380 μm, from 130 μm to 370 μm, from 140 μm to 360 μm, from 150 μm to 350 μm, from 160 μm to 340 μm, from 170 μm to 330 μm, from 180 μm to 320 μm, from 190 μm to 310 μm, from 200 μm to 300 μm, from 210 μm to 290 μm, from 220 μm to 280 μm, from 230 μm to 270 μm, from 240 μm to 260 μm, 250 μm, and any and all sub-ranges formed from any of these endpoints.

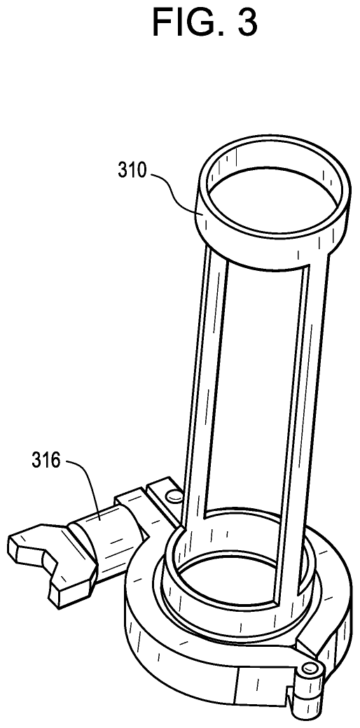

The frame 210 of the delivery vehicle 200 may be formed from any material capable of withstanding the high temperature environment of the molten salt bath. In embodiments, the frame may be stainless steel. FIG. 3 shows a perspective view of a frame 310 according to an embodiment. The frame 310 includes a closure mechanism 316 configured to attach a cover to the delivery vehicle to close an orifice utilized to load TSP into the delivery vehicle. In some embodiments, a separate frame is not included in the delivery vehicle. The delivery may be fabricated utilizing any appropriate method, such as welding, soldering, or mechanical fasteners.

The movement mechanism 142 may be any device capable of moving the delivery vehicle into and out of the molten salt bath. In embodiments, the movement mechanism may be mechanical, such as a lever or gear, or include an electric motor. In some embodiments, the movement mechanism may also be utilized to move other components in the ion exchange process.

The delivery vehicle may be utilized to supply TSP to a molten salt bath by at least partially submerging the delivery vehicle in a molten salt bath contained in tank. The delivery vehicle contains TSP in particulate form. In embodiments, the delivery vehicle may be completely submerged in the molten salt bath. The submergence of the delivery vehicle may be achieved by activating a movement mechanism configured to move the delivery vehicle in contact with the molten salt bath. In some embodiments, the delivery vehicle may be may be submerged by attaching the delivery vehicle to a glass holding cassette configured to hold glass to be ion exchanged in the molten nitrate salt, and then submerging the glass holding cassette.

The molten salt bath may be a molten nitrate salt bath. In embodiments, the molten nitrate salt bath includes lithium nitrate, such as in an amount greater than or equal to 0.5 wt %, greater than or equal to 1.0 wt %, greater than or equal to 1.5 wt %, greater than or equal to 2.0 wt %, or more. In embodiments, the molten salt bath may have a temperature of greater than or equal to 300° C. when the delivery vehicle is submerged.

In embodiments, the method may additionally include removing the delivery vehicle from the molten salt bath. The delivery vehicle may then be disposed of or cleaned out and reused after refilling the delivery vehicle with TSP. In embodiments, the delivery vehicle may remain in the molten salt bath during ion exchange of glass articles in the molten salt bath. In other embodiments, the the delivery vehicle may be removed from the molten salt bath prior to the ion exchange of glass articles in the molten salt bath.

In some embodiments, the method may further include adding TSP to the delivery vehicle prior to use. Additionally, the nitrate components may be mixed with the TSP to improve saturation and the effectiveness of the TSP in regenerating the molten salt bath. The added nitrate may be one of the nitrates in the molten salt bath, such as sodium nitrate or potassium nitrate.

An added benefit of the delivery vehicle is that the sludge produced by reaction of the TSP and lithium nitrate may be at least partially contained within the delivery vehicle. This reduces the sludge buildup on the bottom of the tank, extending bath lifetime and prevents sludge particles from attaching to the surfaces of glass ion exchanged in the molten salt bath.

The tray 160 is configured to retain sludge in the molten salt bath and allow for the convenient removal of the sludge from the molten salt bath. The tray is submerged in the molten salt bath and disposed near the bottom of the molten salt bath tank. This allows sludge to settle on the tray, and be removed along with the tray when buildup becomes excessive or negatively impacts the performance of the molten salt bath. The sludge may include lithium phosphate and/or excess TSP particles, as well as any other reagents that may precipitate during ion exchange, such as silicic acid. Pre-existing methods of dealing with the sludge in molten salt baths require periodic draining of the bath, which is costly and does not necessarily remove all of the sludge from the tank. In some cases, the sludge had to be manually removed from the tank after the tank was drained, as the sludge may harden and adhere to the tank surfaces when cooled below 100° C., risking damage to the tank during the manual removal process.

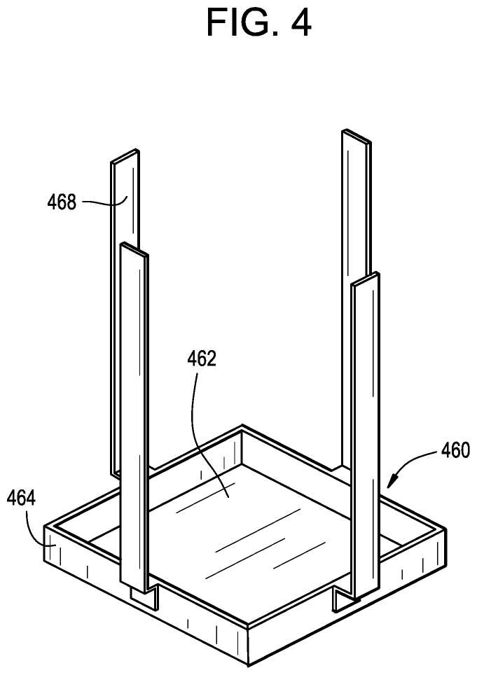

The tray may have any appropriate geometry. In embodiments, the tray has a shape that matches the shape of the bottom of the tank. The effectiveness of the tray may be directly dependent on the amount of the bottom of the tank that the tray covers. FIG. 4 shows a perspective view of a tray 460 that has a square shape for use with a square tank. The tray 460 includes a bottom surface 462 on which sludge may settle. In embodiments, the bottom surface 462 of the tray 460 may include one or more openings to allow the molten salt to drain from the tray. In some embodiments the bottom surface 462 of the tray may be formed from a mesh, such as a stainless steel mesh. The tray 460 also includes a lip 464 extending along the circumference of the tray to retain the sludge on the tray, such as when the tray is removed from the molten salt bath. The tray 460 also includes a support mechanism 468. As shown in FIG. 4, the support mechanism 468 may be hangers configured to extend above the surface of the molten salt bath. In some embodiments, the tray may be supported on the bottom of the molten salt bath tank.

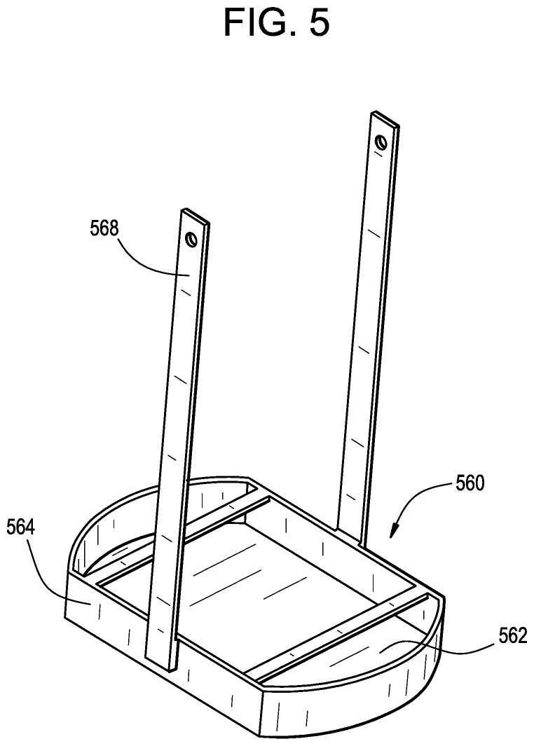

FIG. 5 shows a tray 560 with a shape configured for use with a different shaped tank than the tray of FIG. 4. The tray 560 includes a bottom surface 562 on which sludge may settle. In embodiments, the bottom surface 562 of the tray 560 may include one or more openings to allow the molten salt to flow through the tray. In some embodiments the bottom surface 562 of the tray may be formed from a perforated material or a mesh, such as a stainless steel mesh. The tray 560 also includes a lip 564 extending along the circumference of the tray to retain the sludge on the tray, such as when the tray is removed from the molten salt bath. The lip 564 may include one or more openings to allow the molten salt to flow through the tray, and in some embodiments may be formed from a perforated material or a mesh, such as a stainless steel mesh. The tray 560 also includes a support mechanism 568. As shown in FIG. 5, the support mechanism 568 may be hangers configured to extend above the surface of the molten salt bath.

The tray may additionally include a funneled or angled bottom surface, such that the sludge is preferentially collected in one area of the tray and allow more convenient sludge capture when the tray is removed from the molten salt bath tank. The tray may also include a drain gate, to allow the controlled removal of salt and sludge from the tray. In some embodiments, the tray may be configured to support a glass holding fixture during ion exchange without the fixture contacting the sludge retained by the tray.

The tray may be fabricated from any material capable of withstanding the molten salt bath environment. In embodiments, the tray may be fabricated from stainless steel.

The method of utilizing the tray in a molten salt bath includes submerging the tray in the molten salt bath contained in a tank and disposing the tray near the bottom of the tank. The tray may have shape that substantially matches the interior shape of the bottom of the tank. TSP is then added to the molten salt bath that contains lithium nitrate. TSP may be added periodically to the bath until the sludge accumulation reaches the capacity of the tray. After the accumulation of sludge on the tray, the tray is removed from the molten salt bath along with the sludge.

In embodiments, a replacement tray may be submerged in the molten salt bath after removal of the tray and sludge. The replacement tray may have the same design as the tray that was removed. The use of additional trays reduces downtime by allowing the trays to be cleaned of sludge offline. The method may additionally include cleaning the sludge from the trays removed from the molten salt bath.

The tray may be utilized with a molten nitrate salt bath. In embodiments, the molten nitrate salt bath includes lithium nitrate prior to the addition of the TSP, such as in an amount greater than or equal to 0.5 wt %, greater than or equal to 1.0 wt %, greater than or equal to 1.5 wt %, greater than or equal to 2.0 wt %, or more. In embodiments, the molten salt bath may have a temperature of greater than or equal to 300° C. when the tray is in use.

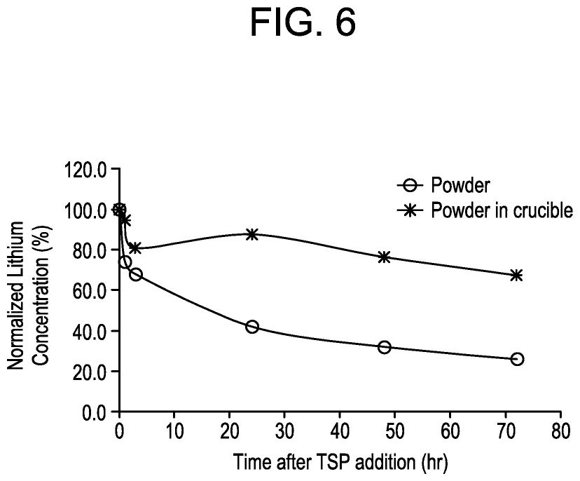

To demonstrate that the delivery vehicle approach described herein is capable of reducing sludge accumulation in the tank, TSP powder was placed in a quartz crucible and submerged in a molten salt bath. The molten salt bath was at a temperature of 390° C. and contained 62 wt % KNO₃, 37 wt % NaNO₃, and 1 wt % LiNO₃. After 72 hours, the sludge produced by the reaction of the TSP and the lithium nitrate was well contained in the crucible. This indicates that the reaction between the TSP and lithium nitrate occurs primarily at the surface of the TSP particles, and sludge should accumulate where the TSP particles are located, such as inside the delivery vehicle. Additionally, after 72 hours, the concentration of LiNO₃ in the molten salt bath was reduced to 0.7 wt % as shown in FIG. 6 even with the TSP contained in the crucible as opposed to free powder added to the bath, indicating that the addition of TSP to the bath in a localized area is an effective method of regenerating the bath.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. An apparatus, comprising:
a tank containing a molten nitrate salt;
a delivery vehicle at least partially submerged in the molten nitrate salt,
wherein the delivery vehicle comprises:
trisodium phosphate particles with a minimum particle size,
a plurality of openings with a maximum opening size less than or equal to the minimum particle size of the trisodium phosphate.

2. The apparatus of claim 1, wherein the delivery vehicle further comprises a metal mesh, and a plurality of openings are formed in the metal mesh.

3. The apparatus of claim 2, wherein the delivery vehicle further comprises a frame supporting the metal mesh.

4. The apparatus of claim 1, wherein the molten nitrate salt comprises LiNO₃.

5. The apparatus of claim 1, wherein the delivery vehicle is fully submerged in the molten nitrate salt.

6. The apparatus of claim 1, further comprising a movement mechanism configured to move the delivery vehicle into and out of contact with the molten nitrate salt.

7. A method, comprising:
at least partially submerging a delivery vehicle in a molten nitrate salt contained in a tank,
wherein:
the molten nitrate salt comprises LiNO₃, and
the delivery vehicle comprises:
trisodium phosphate particles with a minimum particle size,
a plurality of openings with a maximum opening size less than or equal to the minimum particle size of the trisodium phosphate.

8. The method of claim 7, wherein the at least partially submerging the delivery vehicle comprises activating a movement mechanism configured to move the delivery vehicle into contact with the molten nitrate salt.

9. The method of claim 7, further comprising removing the delivery vehicle from contact with the molten nitrate salt.

10. The method of claim 7, wherein the at least partially submerging the delivery vehicle comprises attaching the delivery vehicle to a glass holding cassette configured to hold glass to be ion exchanged in the molten nitrate salt, and submerging the glass holding cassette in the molten nitrate salt.

11. An apparatus, comprising:
a tank containing a molten nitrate salt; and
a tray submerged in the molten nitrate salt and disposed proximate to the bottom of the tank, wherein the tray has a shape that is configured to substantially match the interior shape of the tank, and the tray is removable from the molten nitrate salt.

12. The apparatus of claim 11, wherein the tray comprises stainless steel.

13. The apparatus of claim 11, wherein the tray comprises a plurality of openings configured to allow the flow of the molten nitrate salt.

14. The apparatus of claim 11, wherein the tray is supported by the bottom of the tank.

15. The apparatus of claim 11, wherein the tray is suspended above the bottom of the tank.

16. A method, comprising:
submerging a tray in a molten nitrate salt contained in a tank, wherein the tray is disposed proximate to the bottom of the tank, and the tray has a shape that is configured to substantially match the interior shape of the tank;
adding trisodium phosphate to the molten nitrate salt, wherein the molten nitrate salt contains LiNO₃; and
removing the tray from the molten nitrate salt.

17. The method of claim 16, further comprising submerging a second tray the molten nitrate salt after removing the tray, wherein the second tray is disposed proximate to the bottom of the tank, and the second tray has a shape that is configured to substantially match the interior shape of the tank.

18. The method of claim 16, wherein the molten salt comprises greater than or equal to 1 wt % LiNO₃ prior to the addition of the trisodium phosphate.

19. The method of claim 16, further comprising cleaning the tray after removing the tray from the molten nitrate salt.

20. The method of claim 16, wherein the molten nitrate salt is at a temperature of greater than or equal to 300° C.
